(19) United States
(12) Patent Application Publication
(10) Pub. No.: US 2014/0007503 A1
(43) Pub. Date: Jan. 9, 2014

(54) Hydroponic Growing System

(71) Applicant: Nicole Sroczynski, East Brunswick, NJ (US)

(72) Inventor: Nicole Sroczynski, East Brunswick, NJ (US)

(21) Appl. No.: 13/543,031

(22) Filed: Jul. 6, 2012

(51) Int. Cl. A01G 31/00

(52) U.S. Cl. 47/62 N; 47/62 R

(57) ABSTRACT

A hydroponic growing system for growing plants including a hydroponic vessel for retaining the aqueous nutrient solution. The hydroponic vessel is formed from plastic and has walls that define an interior water-containing compartment. The water containing compartment rests on a base so that the present invention is suitable for table-top use. In the interior of the water-containing compartment is a perforated barrier that spans the interior walls of the container, the barrier positioned parallel to the base. The perforated barrier permits the free flow of nutrient filled aqueous solution and oxygen therethrough. An air hose is connected to an air pump and is inserted into the hydroponic vessel through a grommet-outfitted air hose aperture. The air pump supplies aeration into the aqueous solution. Packages of pre-measured nutrients are supplied with the hydroponic growing system of the present invention which supply nutrients to the water solution.

### CROSS REFERENCE TO RELATED APPLICATION

This application is related to and claims priority and a filing date of the Provisional Application bearing Application No. 60/571,990 and a filing date of Jul. 8, 2011.

### FIELD OF THE INVENTION

The present invention relates generally to a hydroponic growing system for growing plants without soil, and more specifically a hydroponic growing system that includes a hydroponic vessel having a removable perforated barrier for supporting the plants which barrier permits the free flow of aqueous solution and oxygen therethrough.

### BACKGROUND OF THE INVENTION

Hydroponics is a systems of growing crops or other plants or vegetation without a soil medium. The plants are provided with all of the nutrients that they require through exposure to a an aqueous solution containing dissolved nutrients and oxygen.

There are numerous advantages of hydroponic growing systems. Among these advantages are that no soil is required, the water stays in the system and can therefore be reused thereby lowering watering expenses, the nutrition levels can be controlled exactly thereby minimizing the wastage of nutrients or alternatively under-feeding the plants, and it usually results in stable and predictably high crop yields. As such, in comparison to conventional soil-based crop or plant growing, hydroponic growing tends to be much friendlier to the environment.

There are numerous prior art hydroponic growing systems. The disadvantage of many of these prior art hydroponic systems is that they are complex and outside the scope of applicability for the typical small-scale user who desires to grow plants hydroponically at home. An example of such prior art hydroponic growing systems is disclosed in U.S. Pat. No. 7,832,144 132 entitled Hydroponic Growing System.

Therefore it is an objective of the present invention to provide a hydroponic growing system that is simple to understand and to set up for a homeowner or resident and can be utilized on a small-scale basis. Another objective of the present invention is to present a complete and self-contained system, having all of the necessary components to grow plants hydroponically. Yet another objective is to provide a system that is relatively easy to manufacture.

Other objectives, advantages and novel features, and further scope of applicability of the present invention will be set forth in the detailed description to follow, taken in conjunction with the accompanying drawings, will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a hydroponic growing system for growing plants. The present invention hydroponic growing system includes a hydroponic vessel for retaining the aqueous nutrient solution. The hydroponic vessel is formed from plastic or Plexiglass and has walls that define an interior water-containing compartment. The water containing compartment rests on a base so that the present invention is suitable for table-top use. In the interior of the water-containing compartment there is a perforated barrier that spans the interior walls of the container, the barrier positioned parallel to the base. The perforated barrier permits the free flow of nutrient filled aqueous solution and oxygen therethrough. An air hose is connected to an air pump and is inserted into the hydroponic vessel through a grommet-outfitted air hose aperture. The air pump supplies aeration into the aqueous solution. Packages of pre-measured nutrients are supplied with the hydroponic growing system of the present invention which packages supply nutrients to the water solution in the proper concentration.

### BRIEF DESCRIPTION OF THE FIGURES

For a better understanding of the present invention, reference is made to the following description of an exemplary embodiment thereof, considered in conjunction with the accompanying drawings, in which:

FIG. 1 is a right side sectional view of the present invention hydroponic growing system.

FIG. 2 is a right side view of the present invention hydroponic growing system.

FIG. 3 is a rear view of the present invention hydroponic growing system.

FIG. 4 is a front sectional view of the present invention hydroponic growing system.

FIG. 5 is a top view of the present invention hydroponic growing system.

FIG. 6 is a top view of the perforated barrier of the present invention hydroponic growing system.

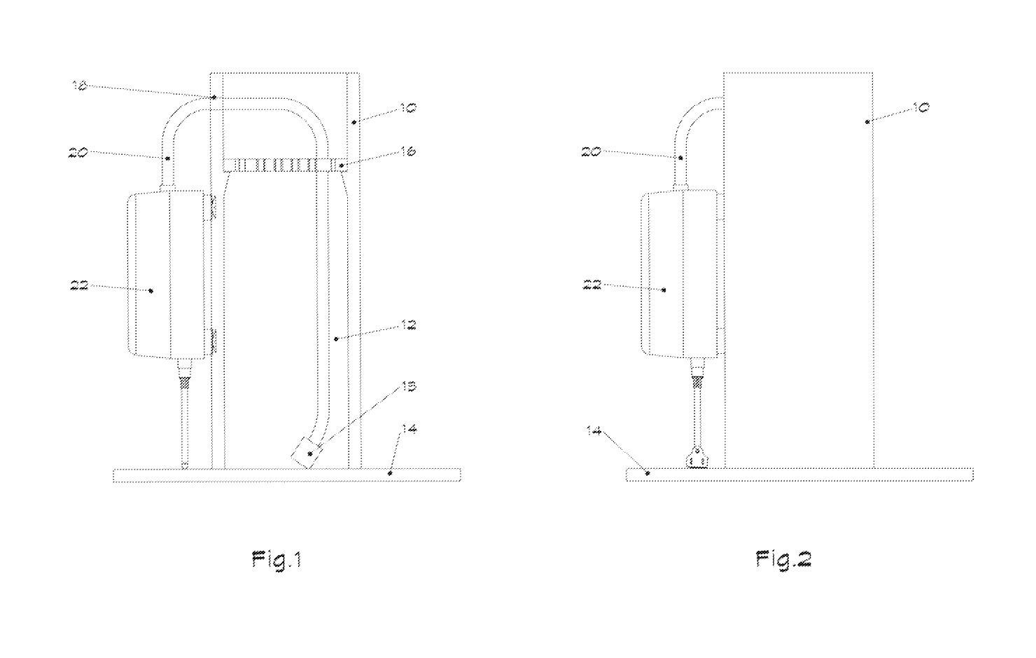

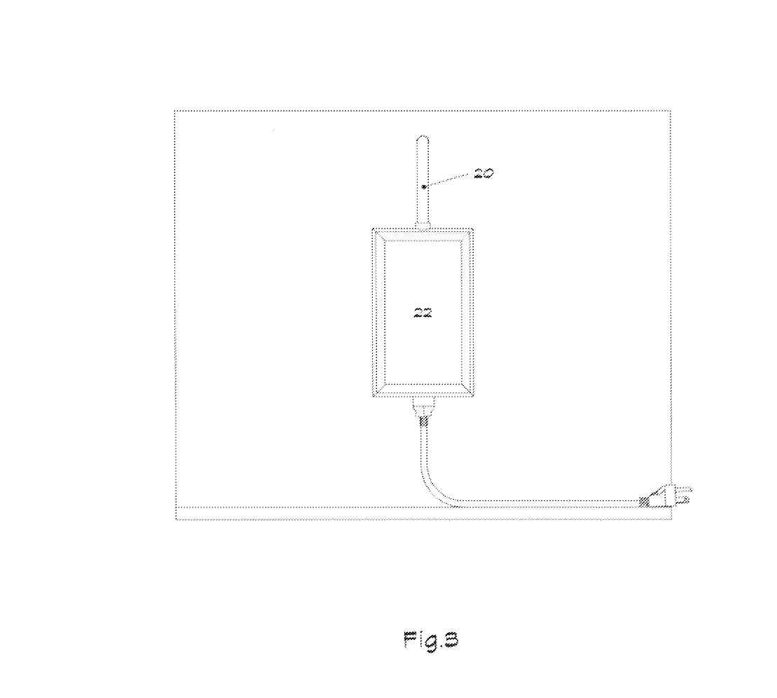

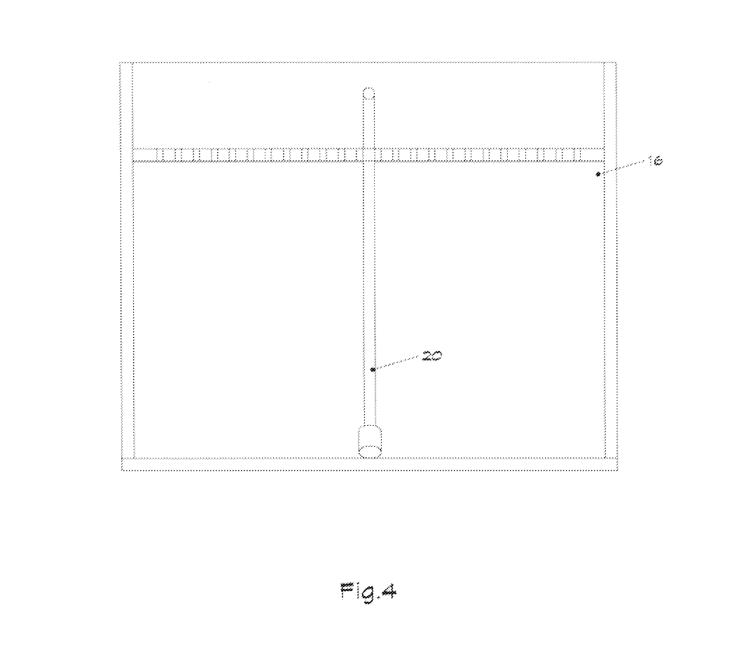

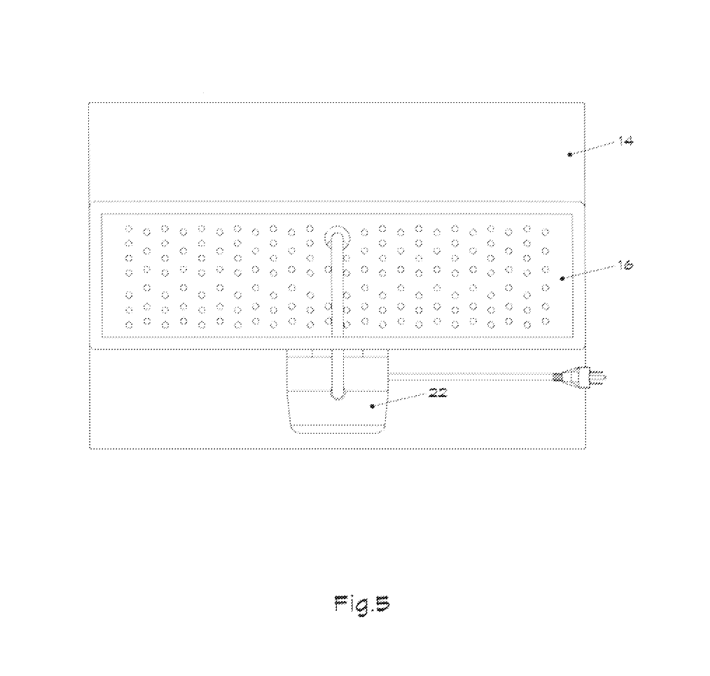

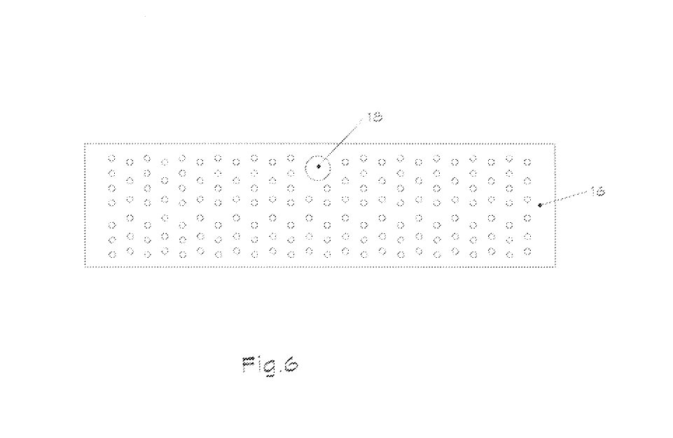

### DETAILED DESCRIPTION OF THE INVENTION

The present invention is a water-culture hydroponic growing system for growing crops or other plants without the use of soil. Typically, crops or plants are grown in soil. However, hydroponics is a system for growing plants without the use of soil. The required nutrients to feed the plants are all supplied by providing an aqueous solution containing the said dissolved nutrients. The roots of the plants are submerged into the nutrient-laden aqueous solution, thereby providing nutrition to the plant. In this manner, the exact amount of water, nutrients and oxygen can be provided thereby insuring no excess water and nutrients are supplied and likewise, there is no shortage of water and nutrients. The present invention hydroponic growing system is self contained, having all of the essential requirement for a small scale user to use, and is easy to manufacture and use.

Looking at the figures, the hydroponic growing system of the present invention includes a hydroponic vessel 10 for retaining the aqueous nutrient solution. The hydroponic vessel of this invention is formed from Plexiglas or other suitable rigid plastic. The plastic should be food-quality plastic to ensure safety if edible plants are grown in the apparatus. It has been found that it is advantageous if the vessel is not transparent by adding color to the plastic which helps to inhibit the growth of algae. The various panels employed to assemble the hydroponic vessel may be glued together to form the vessel. Alternatively, the vessel may be molded into its required configuration.

Looking more closely now at the hydroponic vessel 10, the water containing compartment 12 of the vessel is generally rectangular in cross-section and the front, back and side walls of the vessel define an interior compartment for holding the aqueous solution. However, it is within the scope of the present invention to provide water containing compartments of configurations other than rectangular. Likewise, the dimensions of the water containing compartment are not critical. Specifically, the water containing compartment as shown in the figures has an approximate height of eight inches, an approximate width of two inches, and an approximate depth of ten inches.

The entire water container compartment is attached to a base 14 which base provides support to the hydroponic vessel. As such, the hydroponic growing system of the present invention is free standing and is thus perfectly suited for table-top or desk-top use.

A perforated barrier 16 spans the interior of the water containing compartment in a direction substantially parallel to the base. The perforated barrier is situated approximately ⅔ of the way up inside the interior of the water container and spans the front, back and side walls of the container. Examining the perforated barrier closely, it can be seen that it contains perforations which permit the free flow of the nutrient laden aqueous solution and oxygen therethrough. The perforated barrier provides support for potted plants which are placed upon it and inside the water container. The perforated barrier may be removable to facilitate cleaning of the system.

An aperture 18 is located in the water container element through which air tubing 20 is inserted. More specifically, the aperture is located on the back panel of the water containing compartment, near the top and above the level of the perforated barrier 16. A rubber or plastic grommet is inserted into the aperture so that an air-tight seal is created when the air tubing is inserted. The air tubing is typical off-the-shelf air tubing of the type employed by aquarium owners. The air tubing extends downward through the perforated barrier and down toward the bottom of the water containing element. Attached to the bottom of the air tubing is an air stone 13 which air stone facilitates even distribution of air and oxygen throughout the system thereby supplying oxygen to the roots of the plant.

External to the hydroponic vessel, the air tubing is attached to an electric air pump 22. As shown the Figures, the air pump is attached to the back panel of the hydroponic vessel through employment of suction cups. Alternatively, the air pump may simply rest on the table top upon which the hydroponic vessel is placed. The air pump pumps air through the air tube, through the air stone, and into the aqueous solution thereby supplying necessary aeration to the solution.

Included with the system of the present invention are packages of nutrients. The packets of nutrients are pre-measured, thereby supplying the correct amount of nutrition when mixed with a pre-determined amount of water to be used in the hydroponic vessel.

Also included may be a light, which light clips on to the vessel and which light illuminates the entire system and may be optimized to provide the appropriate wavelength of light to accelerate photosynthesis.

To utilize the present invention hydroponic growing system, water is filled into the water containing compartment. The water level should be chosen so that the water rises above the level of the perforated barrier. However, the water should not be filled all the way to the top of the water container, to allow room for plants. Now, pre-measured nutrients from one of the packages is dissolved into the water to create an aqueous solution containing the proper concentration of nutrients. Then, plants are placed on the perforated barrier. The plants may be inside permeable pots, or the plant's roots may be bound within mesh. Furthermore, the roots of the plants can be supported by gravel thereby anchoring the roots. Finally, the electric air pump is activated to provide necessary aeration to the plants through the aqueous nutrient solution. As such, a simple, easy to use, self-contained, table-top hydroponic growing system is presented.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope or the invention.

What is claimed:

1. A hydroponic growing system for growing plants, comprising:
a non-transparent hydroponic vessel, said hydroponic vessel having an interior for retaining an aqueous solution for providing nutrition to the plants, said hydroponic vessel having walls that define an interior water compartment, said hydroponic vessel supported on a base for placement on a table;
a perforated barrier for supporting said plants in said interior of said hydroponic vessel, said perforated barrier spanning said walls, said perforated barrier substantially parallel to said base;
said hydroponic vessel having an air hose aperture;
an air pump for providing aeration for said aqueous solution, said air pump is connected to an air hose said air hose entering into said hydroponic vessel through said air hose aperture; and
nutrient packages for introducing pre-measured nutrition into said aqueous solution in a desire concentration.

2. A hydroponic growing system for growing plants, comprising:
a hydroponic vessel, said hydroponic vessel having an interior for retaining an aqueous solution for providing nutrition to the plants, said hydroponic vessel having walls that define an interior water compartment; and
a perforated barrier for supporting said plants in said interior of said hydroponic vessel, said perforated barrier spanning said walls, said perforated barrier substantially parallel to said base.

3. The hydroponic growing system for growing plants of claim 2 wherein said hydroponic vessel is non-transparent.

4. The hydroponic growing system for growing plants of claim 2 further including nutrient packages for introducing pre-measured nutrition into said aqueous solution in a desire concentration.

5. The hydroponic growing system for growing plants of claim 2 further including an air hose aperture.

6. The hydroponic growing system for growing plants of claim 5 further including an air pump for providing aeration for said aqueous solution, said air pump is connected to an air hose said air hose entering into said hydroponic vessel through said air hose aperture

7. The hydroponic growing system of claim 2 further including a light clipped onto said hydroponic vessel.
